(19) United States
(12) Patent Application Publication
(10) Pub. No.: US 2009/0231129 A1
(43) Pub. Date: Sep. 17, 2009

(54) WIRELESS JANITORIAL SUPPLY/EMERGENCY MONITORING SYSTEM

(75) Inventors: Lewin Edwards, Forest Hills, NY (US); Richard Watson, South Hempstead, NY (US); Michael Garavuso, Lindenhurst, NY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/048,894

(22) Filed: Mar. 14, 2008

(51) Int. Cl. G08B 21/00

(52) U.S. Cl. 340/540

(57) ABSTRACT

A monitoring system and method of monitoring a predetermined maintenance event including one or more sensors for transmitting an alert signal of the predetermined maintenance event to a transceiver device and messaging device which may be included in a control panel. The transceiver device receives the alert signal transmission from the sensor, and the messaging device transmits an alert message to a receiving device. The receiving device may be embodied as a pager or a cell phone for notifying a user of the predetermined maintenance event.

### FIELD OF THE INVENTION

The present invention relates to a monitoring system and method thereof, and more particularly, a monitoring system and method for monitoring a predetermined maintenance event.

### BACKGROUND OF THE INVENTION

Generally, janitorial and maintenance services are required to monitor and maintain infrastructure, such as, bathrooms, faucets, water coolers, and a plurality of supplies. The maintenance services may also include checking and replenishing supplies. Commercial buildings frequently house several unrelated tenants, with the janitorial service provided by a landlord who is responsible for monitoring facilities. In another scenario, bathrooms and other facilities are often spread over a campus, for example, a college campus or a company campus. Such facilities require monitoring, maintenance, and immediate action when a maintenance event occurs, such as, flooding, power outage, or an emergency item is moved, e.g., a fire extinguisher, or a critical supply is low or missing, or vandalism occurs.

Therefore, janitorial and maintenance facilities which can be the epicenter of maintenance events can be spread out in many locations in a building and/or over a campus. The facilities are thereby difficult to monitor, and responding to a maintenance event can be delayed. Solution to these problems is inadequate and typically includes time intensive inspections and monitoring by maintenance personnel.

It would therefore be desirable to have a monitoring system or method for monitoring multiple facilities in a building or campus. It would further be desirable for such a monitoring system to notify maintenance personnel of a maintenance event. It would also be desirable to reduce the need for maintenance personnel to monitor and inspect facilities and supplies.

### SUMMARY OF THE INVENTION

In an aspect of the invention, a monitoring system includes at least one sensor for transmitting an alert signal of a predetermined maintenance event. A transceiver device receives the transmission of the alert signal from the sensor and communicates with a messaging device. The messaging device sends an alert message to a receiving device for notifying of the predetermined maintenance event. The messaging device communicates with a computer for analyzing the alert signal and determining a specified notification as the alert message, and the messaging device sends the specified notification to the receiving device. The specified notification may include a predetermined communication corresponding to the maintenance event. For example, the specified notification may include a predetermined text message. In one embodiment of the invention, the messaging device may select from a plurality of alert messages which corresponds to a particular maintenance event. In another embodiment, the receiving device is a personal alert device which may include a beeper or a cell phone.

In a related aspect, a control panel includes multiple zones corresponding to event types and includes a zone for maintenance events. The control panel includes the computer for analyzing the alert signal and determining which of a plurality of alert messages are sent. The alert signal may include a code, and the control panel computer analyzes the code and determines the predetermined maintenance event, and the control panel transmits the alert message to a designated receiving device corresponding to the maintenance event. The control panel may further include an emergency zone, and the zone for maintenance events is a non-emergency zone. The system may further include a plurality of sensors corresponding to a plurality of predetermined maintenance events. The sensors may include a motion sensor, and also may include lever arm microswitch sensors, flood sensors, shock sensors, water flow sensors, temperature sensors, pressure sensors, and gas and vapor detectors.

In another aspect of the invention, a method for monitoring a specified area includes: transmitting an alert signal of a predetermined maintenance event using at least one sensor; receiving the transmission from the sensor and transmitting an alert message using a messaging device; receiving the alert message using a receiving device; and notifying a user of the predetermined maintenance event using the receiving device. The method may further include: analyzing the alert signal using a computer; determining a specified notification as the alert message using the computer, and sending the specified notification to the receiving device using the transceiver device. The specified notification may include a predetermined text message. The method may further include: selecting from a plurality of alert messages corresponding to particular maintenance events; and sending the alert message to the selected receiving device using the messaging device. Additionally, the method may further include: separating a control panel into multiple zones corresponding to event types including a zone for non-emergency maintenance events and a zone for emergency events; analyzing a code in the alert signal using a computer in the control panel; designating the alert signal as a non-emergency maintenance event type; determining the predetermined maintenance event using the code; and transmitting the alert message to a designated receiving device corresponding to the predetermined maintenance event using the control panel.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a block diagram depicting a monitoring system according to an embodiment of the present invention including one or more sensors capable of transmitting an alert signal, a transceiver device receives the alert signal and a messaging device transmits an alert message to a receiving device embodied as a cell phone or pager; and

FIG. 2 is a block diagram depicting another embodiment of the present invention including one or more sensors capable of transmitting an alert signal to a control panel including a non-emergency maintenance zone having a transceiver and a messaging device for transmitting the alert message to the cell phone or pager.

### DETAILED DESCRIPTION OF THE INVENTION

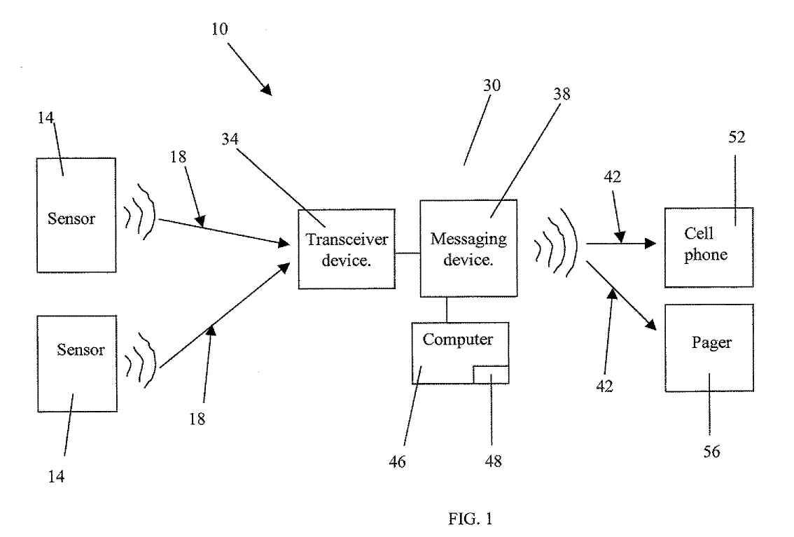

An illustrative embodiment of a monitoring system 10 and method of monitoring a predetermined maintenance event is shown in one embodiment of the invention in FIG. 1. The system includes one or more sensors 14 each for transmitting an alert signal 18 corresponding to predetermined maintenance events. The sensors 14 may include devices detecting, for example, vandalism, flooding, or relocation of fire extinguishers. For example, wireless sensors can be adapted to sense janitorial or maintenance events or conditions. Illustratively, a motion sensor may be attached to fire extinguishers to detect when a fire extinguisher is moved. A lever arm on a microswitch, connected to a wireless contact can be used to sense if a roll of paper towels is depleted. Similarly, a lever arm fitted with a float and connected to a wireless contact may be used to sense if a liquid soap reservoir is depleted. Further, a wireless flood sensor may be installed to check for flooding around a bathroom sink, shower, or toilet. Additionally, shock sensors, water flow sensors, temperature sensors, pressure sensors, and gas and vapor detectors may be used to detect specified maintenance events

A transceiver device 34 communicates, for example, wirelessly or by hard wire to a messaging device 38. The transceiver 34 receives the transmission of the alert signals 18 from the sensors 14. The messaging device 38 transmits an alert message 42 to one or more receiving devices embodied as a cell phone 52, or a personal alert device embodied as a pager 56. The pager may include a radio pacer or short-range radio device, which may be hand held, which receives a message sent directly using a transceiver without accessing an external messaging network. The alert message 42 may be sent to the cell phone 52 and/or the pager 56 with a specified alert message corresponding to the predetermined maintenance event detected by the corresponding sensor 14. Once a cell phone or pager user is notified of the maintenance event by receiving the alert message 42, the user can proceed to remedy the maintenance event, or, for example, contact appropriate personnel for assistance. The alert message may include a code indicating a particular maintenance event, a text message, an automated call or the like.

Further, the messaging device 38 is connected to a computer 46 for analyzing the alert signals 18 and determine a particular maintenance event. For example, one sensor 14 may be designated to detect a flood, and thus sends a predetermined code to the receiver. The computer 46 analyzes the code of the alert message using a program stored in a storage device 48 of the computer 46 to determine the code's corresponding maintenance event and location of the sensor 14. Other data of the maintenance event may also be analyzed and stored, for example, event times and measurements.

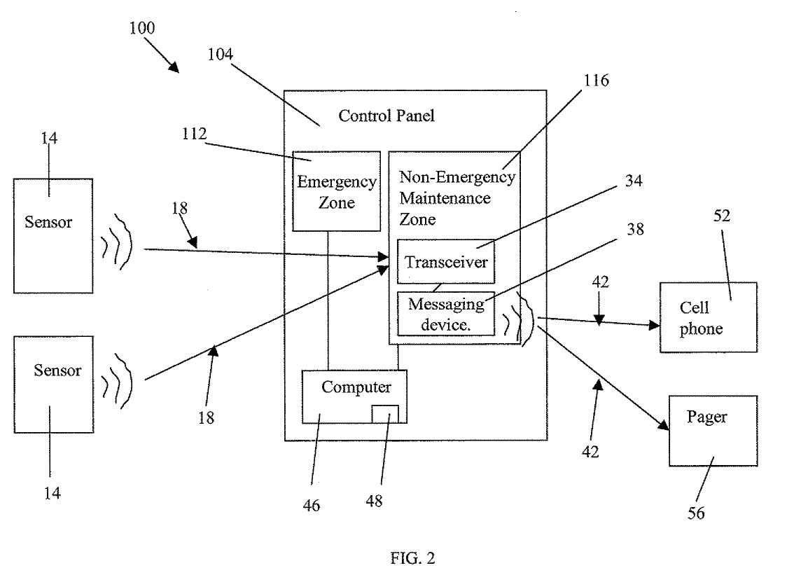

In another embodiment, shown in FIG. 2, a monitoring system 100 includes a control panel 104 including multiple zones embodied as an emergency zone 112 and a non-emergency maintenance zone 116. The control panel 104 may be, for example, a combination system having an emergency zone 112 for controlling a fire detection or burglary detection system. The non-emergency maintenance zone 116 is a subsystem of the control panel 104. Similarly to the monitoring device 10 shown in FIG. 1, the sensors 14 transmit alert signals 18 when a maintenance event occurs to the transceiver 34 communicating with the messaging device 38. However, in the monitoring system 100, the transceiver 34 and the messaging device 38 are part of the non-emergency maintenance zone 116 in the control panel 104. The non-emergency maintenance zone 116 does not send an alarm to emergency personnel as would the emergency zone 112. The non-emergency maintenance zone 116, may send an alert signal 42 to a non-emergency central station (not shown) for receiving an alert indicating a non-emergency. The exemplary central station is an example of another receiving device used by the non-emergency maintenance zone 116, and may include a janitorial contractor, or other service provider. Both the non-emergency maintenance zone 116 and the emergency zone 112 communicate with the computer 46 for analyzing the alert signals regarding the monitoring system 100 shown in FIG. 2. Additionally, similarly to the monitoring system 10 shown in FIG. 1, the messaging device 38 transmits an alert message 42 to the cell phone 52, and/or the pager 56. Alternatively, an alert message may be sent to the control panel 104 for displaying a notification message, for example on a keypad of an exiting alarm system. The notification message may include a description of the maintenance event or a code indicating a specified maintenance event. Thereby, maintenance staff checking the control panel 104 for messages would be alerted to a maintenance event. One advantage of this embodiment is that the cost of personal devices is eliminated. Another advantage is that the alert message can be received by maintenance personnel in an environment where radio transmission is forbidden or the use of hand held devices is forbidden for otter reasons. Additionally, the control panel 104, shown in FIG. 2, or the messaging device 38, shown in FIG. 1, can be connected to a public address system for announcing maintenance events using a voice synthesizer.

While the present invention has been particularly shown and described with respect to preferred embodiments thereof it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A monitoring system, comprising:
at least one sensor for transmitting an alert signal of a predetermined maintenance event;
a transceiver device for receiving the transmission of the alert signal from the sensor and sending a message signal; and
a messaging device for receiving the message signal from the transceiver device, the messaging device communicating with a computer for processing and evaluating the message signal from the transceiver device, and the messaging device sending an alert message corresponding to the alert signal for notifying of the predetermined maintenance event.

2. The system of claim 1, further including:
a receiving device for receiving the alert message from the messaging device for notifying of the predetermined maintenance event.

3. The system of claim 2, wherein the computer analyzes the alert signal and determining a specified notification as the alert message, and the messaging device sending the specified notification to the receiving device.

4. The system of claim 3, wherein the specified notification includes a predetermined communication corresponding to the maintenance event.

5. The system of claim 4, wherein the specified notification includes a predetermined text message.

6. The system of claim 1, wherein the messaging device selects from a plurality of alert messages corresponding to particular maintenance events.

7. The system of claim 1, wherein the alert message is a personal alert device message.

8. The system of claim 1, wherein the alert message is a text message to a cell phone.

9. The system of claim 1, further including:
a control panel including the transceiver device, the messaging device and the computer, and the control panel includes multiple zones corresponding to event types and includes a zone for maintenance events.

10. The system of claim 9, wherein the alert signal includes a code, and the computer analyzes the code and determines the predetermined maintenance event, and the control panel transmits the alert message to a designated receiving device corresponding to the maintenance event.

11. The system of claim 9, wherein the control panel includes an emergency zone and the zone for maintenance events is a non-emergency zone.

12. The system of claim 1, further including a plurality of sensors corresponding to a plurality of predetermined maintenance events.

13. The system of claim 12, wherein the sensors include a motion sensor.

14. The system of claim 13, wherein the sensors include motion sensors, lever arm microswitch sensors, flood sensors, shock sensors, water flow sensors, temperature sensors, pressure sensors, and gas and vapor detectors.

15. A method for monitoring a specified area, comprising:
transmitting an alert signal of a predetermined maintenance event using at least one sensor;
receiving the transmission from the sensor and transmitting an alert message using a messaging device;
receiving the alert message using a receiving device; and
notifying a user of the predetermined maintenance event using the receiving device.

16. The method of claim 15, further including:
analyzing the alert signal using a computer communicating with the messaging device;
determining a specified notification as the alert message using the computer; and
sending the specified notification to the receiving device using the messaging device.

17. The method of claim 16, wherein the specified notification includes a predetermined text message.

18. The method of claim 15, further including:
selecting from a plurality of alert messages corresponding to particular maintenance events.

19. The method of claim 15, further includes:
separating a control panel into multiple zones corresponding to event types including a zone for non-emergency maintenance events and a zone for emergency events;
analyzing a code in the alert signal using the computer;
designating the alert signal as a non-emergency maintenance event type;
determining the predetermined maintenance event using the code; and
transmitting the alert message to a designated receiving device, the alert message corresponding to the predetermined maintenance event.
